(19) United States
(12) Patent Application Publication
(10) Pub. No.: US 2026/0289513 A1
(43) Pub. Date: Sep. 24, 2026

(54) DOCUMENT PROCESSING SYSTEM

(71) Applicant: Bank of America Corporation, Charlotte, NC (US)

(72) Inventors: Priscilla Baldari, Brick, NJ (US); Michael Conti, Westwood, NJ (US); Geoffrey Cooper, New York, NY (US); Biswajit Mohapatra, Robbinsville, NJ (US); Douglas Frichtel, Philadelphia, PA (US); Arvind Venkatesan, Plainsboro, NJ (US); Sriram Srinivasavaradhan, Medavaskkam (IN); Prahalath Jayaraman, Selaiyur (IN); Udaybir Singh Dang, Metuchen, NJ (US)

(21) Appl. No.: 19/082,428

(22) Filed: Mar. 18, 2025

(51) Int. Cl. G06Q 10/107; G06F 16/93; G06Q 40/06

(52) U.S. Cl. CPC G06Q 10/107; G06F 16/93; G06Q 40/06

(57) ABSTRACT

Methods for processing documents may receive documents. Methods may display, on a user interface, the received documents. Methods may receive, at the user interface, approval for the documents. Methods may trigger, at the user interface, initiation of a document transfer upon approval receipt. Methods may identify a client associated with the document. Methods may retrieve, from the database, metadata relating to the client. Methods may determine, based on the metadata, a delivery preference of the client. Methods may transfer the document to a repository. Methods may transfer the document to an e-mail processing system when the metadata indicates that the client has selected electronic delivery. Methods may transfer the document, together with metadata relating to a physical mailing address of the client, to a print processor when the metadata indicates that the client has selected physical mail delivery.

### FIELD OF TECHNOLOGY

Aspects of the disclosure relate to document processing.

### BACKGROUND OF THE DISCLOSURE

The field of alternative investments, including hedge funds and private equity funds, may also be referred to as illiquid investments.

A client may hold to ten to fifteen, or any other suitable number of different hedge funds and private equity funds. Conventionally, each of the different fund managers maintain a unique online portal and website and/or deliver client communications via paper copies through traditional postal services. As such, a client requesting electronic communications would be provided with multiple login details—i.e., a distinct login and website for each fund manager. The client may use the portals to access fund material. Each time a client wants to access fund material, the client is required to retrieve login details for the specific fund manager and use the retrieved login details to obtain the fund material. The different websites, included in the different login details, are typically third-party sites that are not integrated with the client's broader, brokerage relationship or brokerage online access.

Additionally, each fund manager was required to maintain client preferences, such as whether the client elected electronic communications or paper communications. A client requesting electronic delivery was required to access each of the different fund manager portals with which the client had an account to enroll in electronic delivery.

This disjointed experience requires a client to access multiple portals to obtain fund material. Additionally, at times, an advisor does not have access to the portals. Thus, this disjointed experience is burdensome for both the client and the advisor. Furthermore, computer resources are wasted when the client or advisor is required to store, maintain and update multiple login details, which may frequently change. Additionally, fund material may be lost when a client is required to access multiple portals to obtain the documents.

As such, it would be desirable to create a platform that removes the burden from clients and advisors to access fund material, access documents and/or elect delivery preferences via multiple, and disparate, portals. Such a platform may enhance and simplify customer experience. Such a platform may eliminate a disjointed client experience caused by the client accessing multiple disjointed portals where each of the portals accesses disparate backend systems. Such a platform may deliver all relevant communications to the client in a format that the client has preselected.

### SUMMARY OF THE DISCLOSURE

Systems, apparatus and methods for a consolidated streamlined experience for users (including clients and client-advisor agents) of alternative investments, such as multiple hedge funds and private equity funds, are provided.

A financial advisor may recommend a client invest in a particular hedge fund product. The system may process onboarding of the recommended hedge fund product to the client's broader financial institution platform. The system may include connectivity with an underlying fund manager associated with the recommended hedge fund product.

It should be noted that, with illiquid investments, the positions—i.e., the investments of the hedge fund product—are registered directly in the client's name. Registering the positions directly in the client's name may differentiate between an alternative investment system and a mutual fund system. In a mutual fund system, all of the positions—i.e., investments—are registered on an omnibus basis—i. e., not specific to a client—and essentially pooled. As such, the mutual fund system manages the operational logistics and sub-accounting.

The system may manage hedge funds and private equity funds. Preferably, the third-parties have direct visibility within the system. Preferably, the clients have direct registration with the fund manager on the transfer agent books and/or records.

The system may enable all of the fund material and/or documents, from disparate sources, to be directed through a single integrated portal. The system may funnel all of the documents from the third-party fund managers. The system may funnel all of the documents from the transfer agents. The system may funnel all of the documents from the administrators.

The system may ingest the documents, in whatever format the fund manager has provided, into a single integrated portal. The single integrated portal may determine, utilizing electronic delivery preferences previously set for the client, a delivery preference for the client. The delivery preference may include whether the document should be printed and mailed to the client, electronically transmitted—i.e., via e-mail—and/or posted for viewing on a client-specific online portal. The single integrated portal may deliver the document to the client.

The system may streamline the pathways in which a fund manager or transfer agent can upload or enter the documents. The pathways may include e-mail, direct upload, physical mail or any other suitable pathway.

Upon receipt of the documents, the system may normalize the documents and the associated metadata. Examples of metadata may include file names, client account number, fund identifier, security identifier, document type and any other attributes of the document that the system may need to learn to ensure that the document is routed appropriately to the client.

Once a document is ingested with the correct attributes, the internal system ensures that, firstly, the account exists—i.e., the account has a holding within the fund identifier (“ID”) that is noted. Secondly, the internal system ensures that all of the metadata fits into an identified pattern. In a first example, the internal system identifies the number of digits in the account number to determine whether the account is a private banking account or a brokerage account. In another example, the internal system identifies delivery/shipping preferences of the client—i.e., does the document need to be physically mailed or electronically mailed. Thirdly, the internal system transfers the document to a document retention system (also referred to herein as a document record repository).

There may be multiple checkpoints prior to transferring the document. A first checkpoint may ensure that the document is right for the account which is indicated. A second checkpoint may verify, with the document retention system to verify that the document and the different document attributes are storable within the document record repository.

The system also includes internal-system-user interface for administrators of the program to view what is actually being done within the system. This differentiates from the prior art, because previously administrators were unable to view the internal workings of a system. The metadata attributes may also be viewable within such an internal-system-user interface. As such, the internal users are enabled to view each of these documents or batches to ensure that the documents are still appropriate for the clients. The viewing by the internal users may occur prior to a formal approval process which accepts, approves and uploads the document into the system.

Additionally, the system may ensure that clients that have selected electronic delivery are able to receive an e-mail notification that the client has received a new document, and it is available within an online portal. The client may be instructed to log in to see fully approved documents that were posted. The system is also integrated with a print system for those clients that have selected print delivery. The system may transmit the documents and the attributes including the client name and mailing address information to the print delivery subsystem.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure; and

FIG. 3 shows yet another illustrative diagram in accordance with principles of the disclosure.

### DETAILED DESCRIPTION OF THE DISCLOSURE

Systems, apparatus and methods for a document processing system are provided. The document processing system may include a document processing engine and a document portal. The document processing engine may include one or more processors, database, a receiver, a review/approve processor and a transfer processor.

The receiver may receive documents from one or more electronic locations. The review/approve processor may control a user interface. The user interface may display the documents. The user interface may receive approval for one or more of the documents. The user interface may trigger initiation of the transfer processor.

The transfer processor may, for each approved document, identify a client associated with the document. The transfer processor may, for each approved document, retrieve, from the database, metadata relating to the client. The transfer processor may, for each approved document, determine, based on the metadata, a delivery preference of the client. The transfer processor may, for each approved document, transfer the document to a document retention system. The transfer processor may, for each approved document, transfer the document to a systematic e-mail processing system when the metadata indicates that the client has selected electronic delivery. The transfer processor may, for each approved document, transfer the document, together with metadata relating to a physical mailing address of the client, to a print vendor and/or processor when the metadata indicates that the client has selected physical mail delivery.

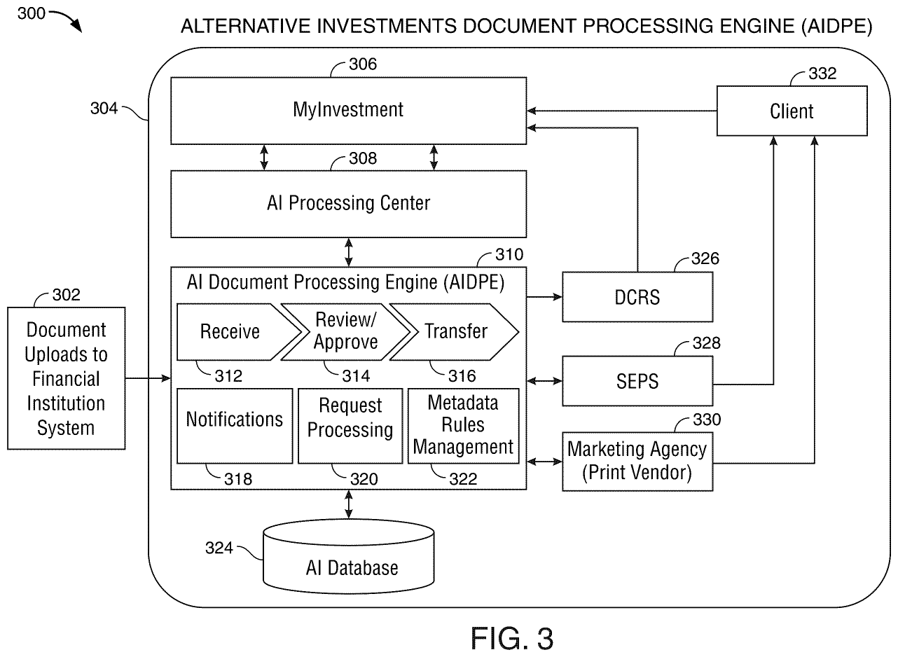

A first document portal may be accessible by the client. The first document portal may display, to the client, contents of the document retention system associated with the client, using an electronic link between the first document portal and the document retention system. The electronic link to the document retention system may be a shallow copy. The shallow copy may be a pointer to the document stored within the document retention system. The first document portal may fail to include long-term storage relating to the document. The first document portal may be the same as, similar to and/or include the MyInvestment portal described in connection with FIG. 3.

A second document portal may be accessible by an advisor. The second document portal may display, to the advisor, contents of the document retention system associated with the advisor's set of clients, using an electronic link between the first document portal and the document retention system. The electronic link to the document retention system may be a shallow copy. The shallow copy may be a pointer to the document stored within the document retention system. The second document portal may fail to include long-term storage relating to the document.

An administrative—i.e., home office—user may access documents directly within the transfer processor. The transfer process may include a local user interface accessible to administrative users. The local user interface accessible to administrative users may be referred to as a third document portal.

The transfer processor may identify a client associated with the document. The transfer processor may retrieve, from the database, metadata relating to the client. The transfer processor may determine, based on the metadata, that a document portal fails to include an account for the client. The transfer processor may flag the document with a physical mail delivery preference based on the determination of the failure of the document portal to include the account for the client. The transfer processor may transfer the document to a document retention system. The transfer processor may transfer the document, together with metadata relating to a physical mailing address of the client, to a print processor.

The document portal may be accessible by an agent. The document portal may receive, from the client, a request to access the document portal. The document portal may create the account for the client within the document portal. The account may generate an access point for the client to access the document portal. The document portal may display, to the client and/or an agent, using an electronic link between the document portal and the document retention system, contents of the document retention system previously associated with the client. The electronic link to the document retention system may be a shallow copy. The shallow copy may be a pointer to the document stored within the document retention system. The document portal may fail to include long-term storage relating to the document.

The document processing engine may include a notifications processor. The notifications processor may transmit one or more notifications to the client within the document portal. The notifications may include a notification that a document associated with the client has been added to the document retention system and is available to the client via the document portal.

The document processing engine may include a request processor. The request processor may receive and respond to requests from clients and/or agents.

The document processing engine may include a metadata rules management processor. The metadata rules management processor may retrieve the metadata associated with the documents. The metadata may be retrieved from the database.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

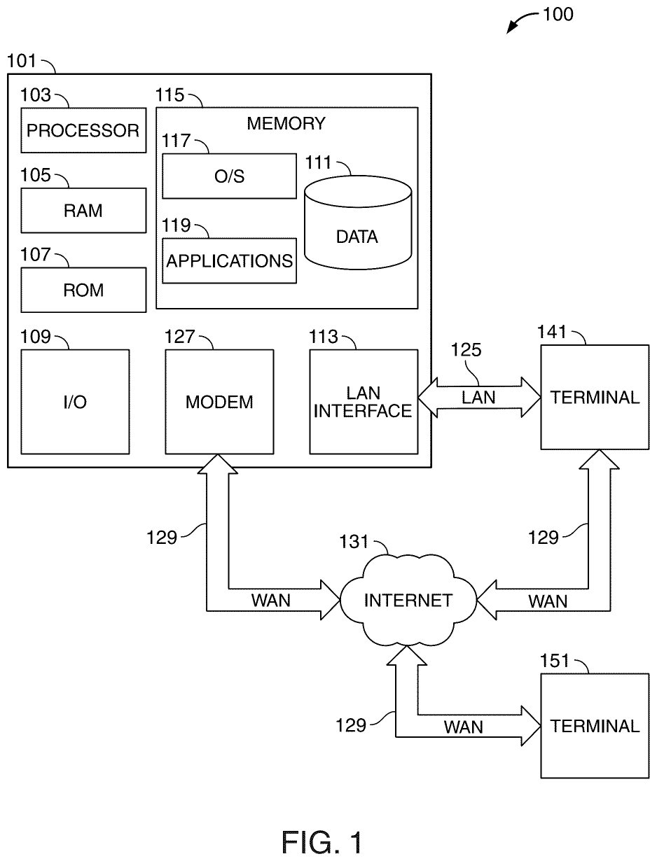

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAS”) , multiprocessor systems, microprocessor-based systems, cloud-based systems, programmable consumer electronics, network PCs, minicomputers, mainframe computers, distributed computing environments that include any of the above systems or devices, and the like.

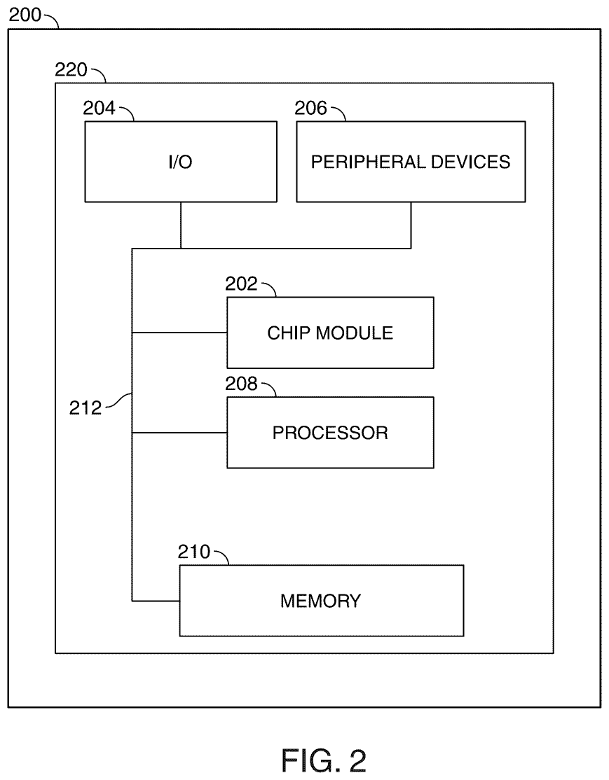

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

FIG. 3 shows an illustrative diagram 300. Illustrative diagram 300 shows a system 304 comprising an alternative investments document processing engine (“AIDPE”) 310. AIDPE 310 may receive data and/or information from AI database 324.

Documents 302 may be input, submitted, entered for processing and review, or received at AIDPE 310, as shown at 312. One or more documents may be uploaded by a fund administrator or any suitable entity. In some embodiments, AIDPE 310 may retrieve documents from one or more locations. AIDPE 310 may be referred to as an entry point into system 304. Received documents 302 may be processed and reviewed at AIDPE 310.

Documents 302 may be reviewed and approved, as shown at 314, at a user interface (“UI”) within AIDPE 310. The UI may be a custom layer for internal associates to review and approve documents 302.

Upon approval of documents 302, AIDPE 310 may transfer, as shown at 326, the approved documents to document retention system (“DCRS”) 326.

AIDPE 310 may identify one or more notifications, as shown at 318, that may be transmittable to one or more stakeholders, such as clients or fund managers. Notifications 318 may map to a systematic e-mail processing system (“SEPS”) 328. SEPS 328 may process and transmit e-mails to clients. The e-mails may include the notifications. The e-mails may be transmitted on a scheduled basis, such as on a predetermined frequency. An exemplary notification may include the following statement: additional data has been added to your portal. Another exemplary notification may include the following statement: a document that has been added to the receiver of this notification's online portal. In such embodiments, the notification may or may not include details relating to the additional data or document. In certain embodiments, the notification may or may not include the document.

AIDPE 310 may also process requests, as shown at 320. The requests may be received from stakeholders, such as clients or fund managers.

AIDPE 310 may also manage metadata rules, as shown at 322. The metadata may be data associated with, and/or used to identify, a document.

Both the request processing 320 and the metadata rules management 322 may be included in an orchestration layer, which may also be referred to as a middleware tier. The orchestration layer or the middleware tier may ensure that the documents and all of the different metadata associated with those documents are isolated or otherwise siloed from a data perspective. As such, the system may be able to identify what documents are received in the system and what documents are being transmitted from the system. It should be noted that the documents themselves are transmitted to DCRS for long-term retention.

AIDPE 310 may identify, based on a preselected client preference, whether the client receives documents electronically or via paper mail. Document notifications, including notifications regarding received documents, are transmitted to SEPS 328 for delivery. SEPS 328 may deliver document notifications to the client 332. Documents identified to be delivered via paper mail are transmitted to marketing agency (print vendor) 330. Marketing agency (print vendor) 330 may process the documents and mail paper copies of the documents to addresses associated with the clients 332. It should be noted that the address of the client may be included in the metadata and/or within a client database.

AIDPE 310 may determine which documents, and related information should be transmitted through an e-mail or paper mail, which documents, and related information should be retrieved from a client database and which documents are received from an external source. Exemplary data that may be retrieved from a client database may include mailing addresses. AIDPE 310 may combine the retrieved mailing addresses with the received documents and route that combined information to marketing agency (print vendor) 330.

A user may select electronic delivery within MyInvestment portal 306. There may be an 80% electronic preference and a 20% paper delivery preference. MyInvestment portal 306 may receive documents from DCRS 326. AI Processing Center 308 may be linked to MyInvestment portal 306. AI Processing Center 308 may also be linked to AIDPE 310.

The default delivery mechanism may transmit documents via marketing agency (print vendor) 330. At times, a client may not have access to a MyInvestment portal 306. Other times, a client may not have signed up for a MyInvestment portal 306 account. However, because streaming occurs between DCRS 326 and MyInvestment portal 306, and DCRS 326 stores all documents that were delivered via paper mail, if a client signs up at a later date—i.e., after a document has been delivered-the client may be able to the access the document upon receiving a MyInvestment portal 306 account.

Client 332 may also be able to access an online investment portal, such as MyInvestment portal 306. MyInvestment portal 306 may include multiple variations. Each variation may be specific to the underlying client. For example, a private bank client may access a first version of MyInvestment portal 306, and a brokerage client may access a second version of MyInvestment portal 306. Entities internal to the system may also be able to access MyInvestment portal 306. It should be noted that all of the documents that were transmitted to the client via SEPS 328 or Marketing agency (print vendor) 330 may be stored within DCRS 326. DCRS 326 may communicate with MyInvestment portal 306. As such, documents previously sent to a client via SEPS 328 or Marketing agency (print vendor) 330 may also be available to a client or other entity for viewing and/or retrieval from My Investment portal 306. It should be noted that documents previously sent via mail may be available to a user via an electronic portal.

MyInvestment portal 306 may maintain a shallow copy of documents which reference DCRS 326. A shallow copy of the documents may include a pointer to a specified location within DCRS 326. The specified location within DCRS 326 may include the document. Each document may have a primary document identifier that can be leveraged for document retrieval. At times, the primary document identifier may be the pointer. It should be noted that the document may not be maintained within MyInvestment portal 306. As such, computer resources may not be wasted on duplicate maintenance of the document.

MyInvestment portal 306 may also include other relevant client information, such as client statements, trade confirmations and any other suitable information.

Both clients and entities internal to the system may be viewing the same documents on the MyInvestment portal 306. As such, entities internal to the system may be able to assist clients because the documents that they are viewing are identical and stored in the same location. Furthermore, there may be only a single copy of each document. As such, an entity may request a view of a document with MyInvestment portal 306. The document may be streamed, from DCRS 326 to MyInvestment portal 306. The entity may view a streamed copy of the document. However, an additional copy of the document may not be stored at MyInvestment portal 306 or any other suitable location. It should be noted that entities internal to the system, such as advisors and administrators, may emulate a client's MyInvestment portal 306 experience and view documents. However, an advisor may also view documents via a second document portal specific to advisors. Additionally, an administrator may also view documents directly within AIDPE 310.

A document may be available via MyInvestment portal 306 based on user or persona identifying information. As such, a user or persona identity may determine which documents are available to the user. For example, a client may have access to client-owned holdings, while an agent may have access to holdings owned by multiple clients. Each document may be flagged to authorize which users have permission to access the document. Such information may be stored within the metadata of each document.

AIDPE 310 may reduce the amount of information and/or documents that an alternative investment user will be required to access. For example, an alternative investment user may be required to access a single portal with a single username and password instead of accessing multiple disparate portals with multiple usernames and passwords. Additionally, storing the document in a single repository (DCRS 326) instead of in multiple locations, such as both MyInvestment portal 306 and DCRS 326, may reduce computing throughput and bandwidth.

AIDPE 310 may also function as a registration service. As such, AIDPE 310 may acknowledge the existence of the documents, record these documents and ensure that each document has associated required data attributes, such as, for example, account numbers.

Thus, methods and apparatus for a DOCUMENT PROCESSING SYSTEM are provided. Persons skilled in the art will appreciate that the present disclosure can be practiced by other than the described embodiments, which are presented for purposes of illustration rather than of limitation and that the present disclosure is limited only by the claims that follow.

1. A document processing system, said document processing system comprising:
a document processing engine, said document processing engine comprising:
a database operable to store client data;
a receiver, said receiver operable to receive:
one or more documents from a plurality of electronic locations; and
metadata relating to each of the one or more documents, the metadata comprising a file name, an account number, a document type and a fund identifier;
one or more hardware processors operable to:
normalize the one or more documents and the metadata;
electronically activate a first checkpoint that determines whether the account number has a holding within the fund identifier;
in response to successful conclusion of the first checkpoint, electronically activate a second checkpoint that determines whether the metadata corresponds to a previously identified pattern; and
in response to successful conclusion of the second checkpoint, electronically activate a third checkpoint that verifies whether the one or more documents and the metadata are storable within a document retention system;
a review/approve processor, said review/approve processor for controlling a user interface, said user interface operable to:
display the received one or more documents;
receive approval for each of the one or more documents; and
trigger initiation of a transfer processor upon receipt of the approval;
the transfer processor, said transfer processor operable to:
for each document:
identify a client associated with the document;
retrieve, from the database, metadata relating to the client;
determine, based on the metadata relating to the client a delivery preference of the client;
transfer the document to the document retention system;
transfer the document to a systematic e-mail processing system when the metadata relating to the client indicates that the client has selected electronic delivery;
transfer the document, together with metadata relating to the client relating to a physical mailing address of the client, to a print vendor when the metadata relating to the client indicates that the client has selected physical mail delivery; and
a first document portal accessible by the client, said first document portal operable to display, to the client, using a first electronic link between the first document portal and the document retention system, contents of the document retention system associated with the client, said first electronic link to the document retention system being a first shallow copy, said first shallow copy being a first pointer to the document stored within the document retention system, wherein the first document portal fails to include long-term storage relating to the document; and
a second document portal accessible by an agent, said second document portal operable to display, to the agent, using a second electronic link between the second document portal and the document retention system, contents of the document retention system associated with the client, said second electronic link to the document retention system being a second shallow copy, said second shallow copy being a second pointer to the document stored within the document retention system, wherein the second document portal fails to include long-term storage relating to the document.

2. The system of claim 1 wherein the document processing engine further comprises a notifications processor operable to transmit one or more notifications to the client within the first document portal.

3. The system of claim 2 wherein the one or more notifications comprises a notification that a document associated with the client has been added to the document retention system and is available to the client via the first document portal.

4. The system of claim 1 wherein the document processing engine further comprises a request processor operable to receive and respond to requests from clients and/or agents.

5. The system of claim 1 wherein the document processing engine further comprises a metadata rules management processor operable to retrieve the metadata relating to the client associated with the documents.

6. The system of claim 5, wherein the metadata relating to the client is retrieved from the database.

7. A document processing system, said document processing system comprising:
a document processing engine, said document processing engine comprising:
a database operable to store client data;
a receiver, said receiver operable to receive:
one or more documents from a plurality of electronic locations; and
metadata relating to each of the one or more documents, the metadata comprising a file name, an account number, a document type and a fund identifier;
one or more hardware processors operable to:
normalize the one or more documents and the metadata;
electronically activate a first checkpoint that determines whether the account number has a holding within the fund identifier;
in response to successful conclusion of the first checkpoint, electronically activate a second checkpoint that determines whether the metadata corresponds to a previously identified pattern; and
in response to successful conclusion of the second checkpoint, electronically activate a third checkpoint that verifies whether the one or more documents and the metadata are storable within a document retention system;
a review/approve processor, said review/approve processor for controlling a user interface, said user interface operable to:
display the received one or more documents;
receive approval for each of the one or more documents; and
trigger initiation of a transfer processor upon receipt of the approval;
the transfer processor, said transfer processor operable to:
for each document:
identify a client associated with the document;
retrieve, from the database, metadata relating to the client;
determine, based on the metadata relating to the client, that a document portal fails to include an account for the client;
flag the document with a physical mail delivery preference based on the determination of the failure of the document portal to include the account for the client;
transfer the document to the document retention system; and
transfer the document, together with metadata relating to the client relating to a physical mailing address of the client, to a print processor;
the document portal accessible by an agent, said document portal operable to:
receive, from the client, a request to access the document portal;
create the account for the client within the document portal, said account generating an access point for the client to access the document portal; and
display, to the client and/or an agent, using an electronic link between the document portal and the document retention system, contents of the document retention system previously associated with the client, said electronic link to the document retention system being a shallow copy, said shallow copy being a pointer to the document stored within the document retention system, wherein the document portal fails to include long-term storage relating to the document.

8. The system of claim 7 wherein the document processing engine further comprises a notifications processor operable to transmit one or more notifications to the client within the document portal.

9. The system of claim 8 wherein the one or more notifications comprises a notification that a document associated with the client has been added to the document retention system and is available to the client via the document portal.

10. The system of claim 7 wherein the document processing engine further comprises a request processor operable to receive and respond to requests from clients and/or agents.

11. The system of claim 7 wherein the document processing engine further comprises a metadata rules management processor operable to retrieve the metadata relating to the client associated with the documents.

12. The system of claim 11, wherein the metadata relating to the client is retrieved from the database.

13. A method for processing documents, the method comprising:
receiving, from an electronic location, at a document processing engine comprising one or more hardware processors and a database operable to store client data:
a document; and
metadata relating to the document, the metadata comprising a file name, an account number, a document type and a fund identifier;
normalize the one or more documents and the metadata;
electronically activating a first checkpoint that determines whether the account number has a holding within the fund identifier;
in response to successful conclusion of the first checkpoint, electronically activating a second checkpoint that determines whether the metadata corresponds to a previously identified pattern; and
in response to successful conclusion of the second checkpoint, electronically activating a third checkpoint that verifies whether the one or more documents and the metadata are storable within a document retention system;
displaying, on a user interface, said user interface at the document processing engine, the received one or more documents;
receiving, at the user interface, approval for each of the one or more documents; and
triggering, at the user interface, initiation of a transfer processor upon receipt of the approval;
identifying, at the document processing engine, a client associated with the document;
retrieving, at the document processing engine, from the database, metadata relating to the client;
determining, at the document processing engine, based on the metadata relating to the client, a delivery preference of the client;
transferring the document from the document processing engine to a document retention system;
transferring the document from the document processing engine to a systematic e-mail processing system when the metadata relating to the client indicates that the client has selected electronic delivery;
transferring the document, together with metadata relating to the client relating to a physical mailing address of the client, from the document processing engine to a print processor when the metadata relating to the client indicates that the client has selected physical mail delivery; and
displaying, on a first document portal accessible by the client, to the client, using a first electronic link between the first document portal and the document retention system, contents of the document retention system associated with the client, said first electronic link to the document retention system being a first shallow copy, said first shallow copy being a first pointer to the document stored within the document retention system, wherein the first document portal fails to include long-term storage relating to the document; and
displaying, on a second document portal accessible by an agent, to the agent, using a second electronic link between the second document portal and the document retention system, contents of the document retention system associated with the client, said second electronic link to the document retention system being a second shallow copy, said second shallow copy being a second pointer to the document stored within the document retention system, wherein the second document portal fails to include long-term storage relating to the document.

14. The method of claim 13 further comprising transmitting one or more notifications to the client within the first document portal.

15. The method of claim 14 wherein the one or more notifications comprises a notification that the document associated with the client has been added to the document retention system and is available to the client via the first document portal.

16. The method of claim 13 further comprising receiving and responding, at the document processing engine, to requests from clients and/or agents.

17. The method of claim 13 further comprising retrieving, from a metadata rules management processor operating within the first document portal, the metadata relating to the client associated with the document.

18. The method of claim 17, wherein the metadata relating to the client is retrieved from the database.
